(19) United States
(12) Patent Application Publication
(10) Pub. No.: US 2026/0119805 A1
(43) Pub. Date: Apr. 30, 2026

(54) AUTOMATED AUDIENCE RESPONSE ESTIMATION AND PRESENTER FEEDBACK

(71) Applicant: Microsoft Technology Licensing, LLC, Redmond, WA (US)

(72) Inventor: Aleksander ØHRN, Oslo (NO)

(21) Appl. No.: 18/931,001

(22) Filed: Oct. 29, 2024

(51) Int. Cl. G06F 40/35; G06V 20/40; G06V 40/16; G06V 40/20

(52) U.S. Cl. CPC G06F 40/35; G06V 20/41; G06V 40/174; G06V 40/20

(57) ABSTRACT

Solutions are disclosed that provide automated audience response estimation (sentiment analysis) and presenter feedback. Examples capture a plurality of multi-modal signals from a first multi-participant interaction session, such as capturing an audio feed, a video feed, a chat, and actions (e.g., hand-raising) from a video teleconference. Timing information is correlated, enabling accurate sentiment analysis across the multi-modal signals, such as nodding in agreement, detected in the video feed, is correlated with spoken words, captured in the audio clip and identified in an automated transcript. This enables reporting audience sentiment to the presenter, in near-real-time (i.e., during the teleconference) in some examples. Some examples combine multi-modal sentiment analysis results from multiple teleconferences in order to create or train a presentation coach that is able to suggest improvements to planned presentations. Some examples are able to identify a particular audience member (e.g., a VIP), and perform individualized sentiment analysis for that person.

### BACKGROUND

Sentiment analysis uses natural language processing (NLP) and machine learning (ML, or artificial intelligence (AI) as used synonymously herein) to analyze and interpret information in a way similar to humans ascertaining another person's emotional state. Sentiment analysis determine whether the information indicates a positive sentiment, a negative sentiment or a neutral sentiment, which may be represented using a numerical score. Common sentiment analysis tools analyze text, such as written material or transcripts. However, analyzing only textual information, without additional context, may lead to unreliable interpretation.

### SUMMARY

The disclosed examples are described in detail below with reference to the accompanying drawing figures listed below. The following summary is provided to illustrate some examples disclosed herein.

Solutions disclosed herein provide for automated audience response estimation and presenter feedback based on sentiment analysis, such as for video teleconferences. Examples capture a plurality of multi-modal signals from a first multi-participant interaction session, wherein the captured plurality of multi-modal signals comprises an audio feed, a video feed, and image stills of participants in the first multi-participant interaction session; correlate timing information across the captured plurality of multi-modal signals; generate a prompt using the captured plurality of multi-modal signals and the correlated timing information, including the audio feed and the image stills; perform sentiment analysis using the prompt with a language model; and; provide a first report to a presenter indicating results of performing the sentiment analysis.

### BRIEF DESCRIPTION OF THE DRAWINGS

The disclosed examples are described in detail below with reference to the accompanying drawing figures listed below:

FIG. 1 illustrates an example architecture that advantageously provides automated audience response estimation and presenter feedback;

FIG. 2 illustrates an exemplary plurality of multi-modal signals, as may be used in examples of the architecture of FIG. 1;

FIG. 3 illustrates an exemplary transcript, as may be used in examples of the architecture of FIG. 1;

FIG. 4 illustrates an exemplary workflow for partitioning the plurality of multi-modal signals of FIG. 2 into separately-analyzed portions;

FIG. 5 illustrates exemplary sentiment analyses workflows, as may be used occur when using examples of the architecture of FIG. 1;

FIG. 6 illustrates performing sentiment analyses, when using examples of the architecture of FIG. 1, both for an entire audience and for a specific selected participant;

FIG. 7 illustrates generation of a report, as may occur when using examples of the architecture of FIG. 1;

FIG. 8 illustrates an exemplary presentation coach that may be part of an example of the architecture of FIG. 1;

FIG. 9 illustrates training of machine learning (ML) or artificial intelligence (AI) models that may be used by examples of the architecture of FIG. 1;

FIGS. 10A, 10B, and 11 show flowcharts illustrating exemplary operations that may be performed when using example architectures, such as the architecture of FIG. 1; and

FIG. 12 shows a block diagram of an example computing device suitable for implementing some of the various examples disclosed herein.

Corresponding reference characters indicate corresponding parts throughout the drawings.

### DETAILED DESCRIPTION

Solutions are disclosed that provide for automated audience response estimation and presenter feedback, such as sentiment analysis for video teleconferences. Examples capture a plurality of multi-modal signals from a first multi-participant interaction session, such as capturing an audio feed, a video feed, a chat, and actions (e.g., hand-raising) from a video teleconference or even signals from outside channels (e.g., contemporaneous emails and chat activity in outer apps that are accessible. Timing information is correlated, enabling accurate sentiment analysis across the multi-modal signals, such as nodding in agreement, detected in the video feed, which is correlated with spoken words, captured in the audio clip and identified in an automated transcript. This enables reporting audience sentiment to the presenter, in near-real-time (i.e., during the teleconference) in some examples. Some examples combine multi-modal sentiment analysis results from multiple teleconferences in order to create or train a presentation coach that is able to suggest improvements to planned presentations. Some examples are able to identify a particular audience member (e.g., a VIP), and perform individualized sentiment analysis for that person.

Audience response estimation attempts to ascertain whether members of an audience like (or approve of) the message to which they are being exposed, by examining reactions that may include those that may be interpreted as liking/disliking, showing surprise, looking bored or distracted, laughing, and others. Some reactions may be readily interpreted as positive or negative, although some may defy (at least initially) categorization as positive or negative. Audience response estimation includes traditional sentiment analysis, which may be automated using machine learning (ML) or artificial intelligence (AI) models. AI and ML are used synonymously herein. However, as used herein, sentiment analysis includes the more generic audience response estimation, which includes reactions that are not readily categorized as liking or disliking.

Aspects of the disclosure solve multiple problems that are necessarily rooted in computer technology, and render computing platforms more effective and valuable, by providing the practical result of using multi-modal signals to enhance the reliability of sentiment analysis. This improves the accuracy of feedback provided to presenters, both in (near) real time during a presentation, as well as for coaching future presenters during preparation. These advantageous results are accomplished, at least in part by, correlating timing information across a captured plurality of multi-modal signals and performing sentiment analysis using the captured plurality of multi-modal signals and the correlated timing information.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

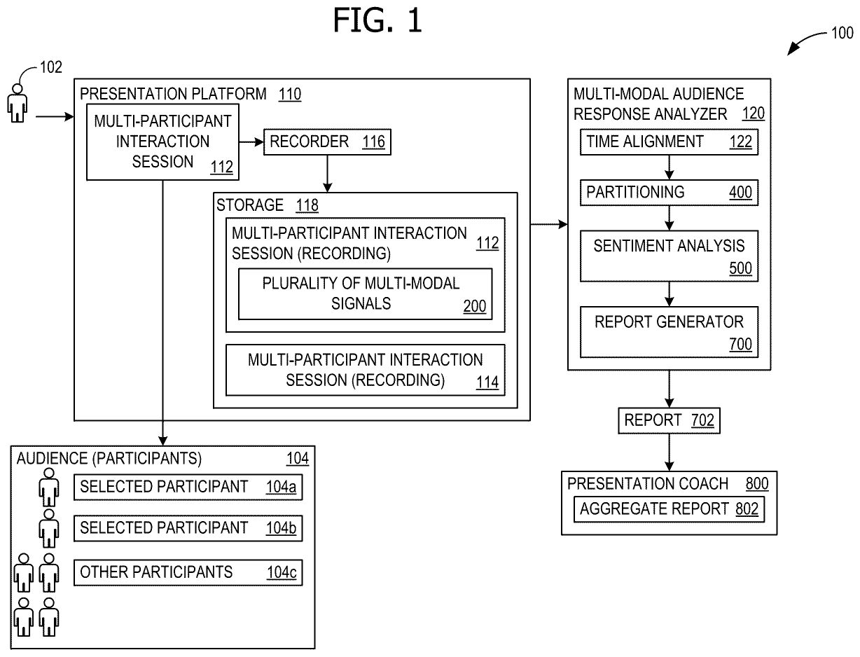

FIG. 1 illustrates an example architecture 100 that provides automated audience response estimation and presenter feedback. That is, architecture 100 provides an audience response analytical engine for multi-participant interaction sessions, such as video conference calls, that captures image stills and fragments from the audio and video feeds to assess audience response and emotion. These multi-modal signals are sent to ML/AI models, which may include large language models (LLMs) and/or multi-modal models (MMs), for performance of sentiment analysis (assessment). Additional data, such as participant actions (hand raising detected via the video teleconference software), concurrent chat activity, head nodding, facial expressions, and laughter or gasps, are time-aligned with a transcript and may be provided as additional material in a prompt for the ML/AI models. The presenter's script, activity, and presented media may be correlated with the audience reactions, to identify contributors to the most positive and negative responses.

As illustrated in FIG. 1, a presenter 102 is using a presentation platform 110 for a multi-participant interaction session 112 with an audience—an aggregation of participants 104. Participants 104 includes a selected participant 104a, another selected participant 104b, and other participants 104c. Selected participants 104a and 104b may be decision-makers or other people (i.e., VIPs) for whom presenter 102 has a special interest in making a good impression. For example, selected participant 104a may be identified as a VIP using a job title or position in an organizational chart that is available in some form to presentation platform 110. A recorder 116 records (captures) multi-participant interaction session 112 and stores it in storage 118. It should be understood that multi-participant interaction session 112 is, at the time of presentation, an abstraction, but is represented in the accompanying Figures as a recording that may be held within storage 118.

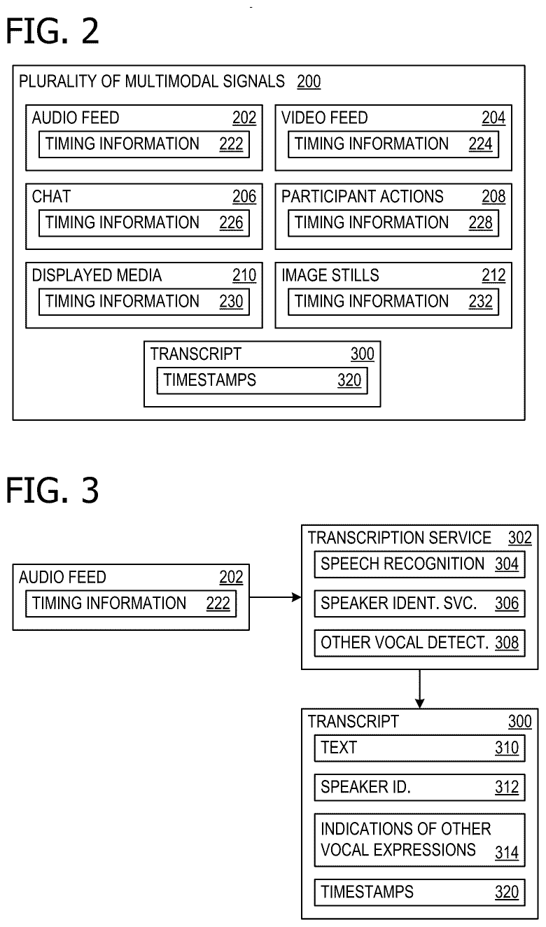

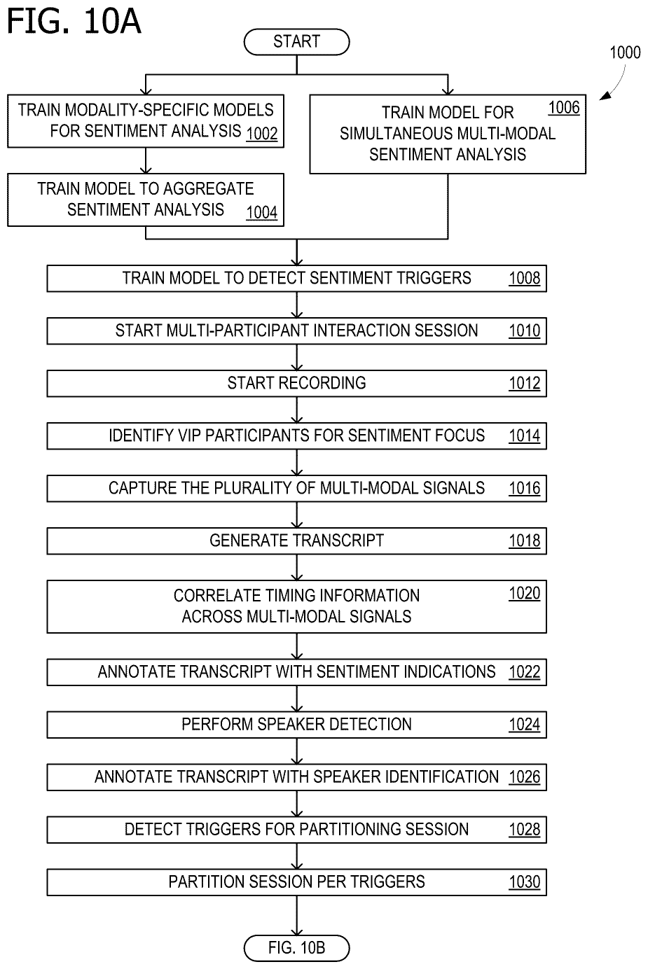

Multi-participant interaction session 112 has a plurality of multi-modal signals 200, which are shown in further detail in FIG. 2, and shown in FIG. 1 as captured plurality of multi-modal signals 200 within storage 118. Storage 118 is also shown as holding a second captured (recorded) multi-participant interaction session 114, which is described in further detail in relation to FIG. 8.

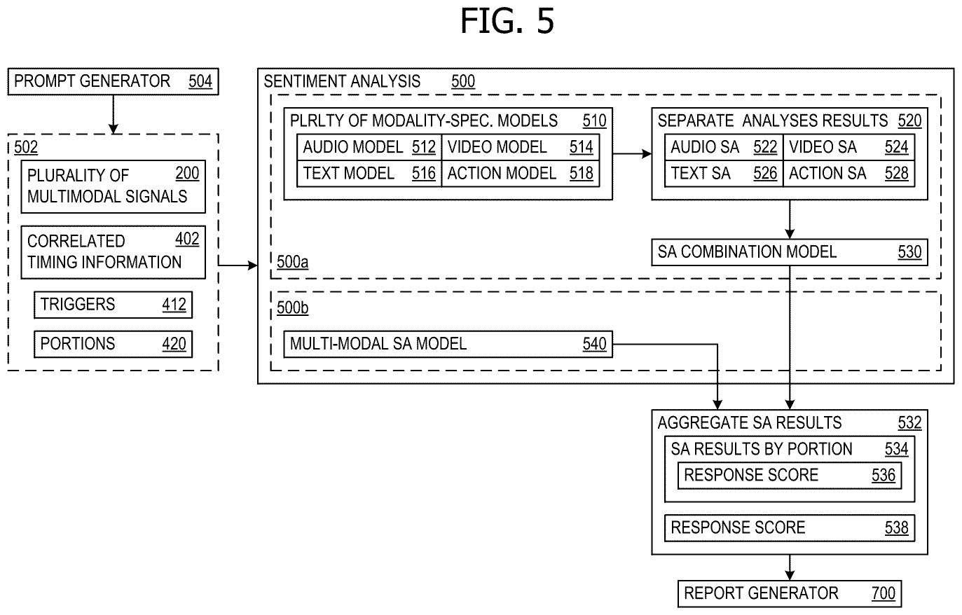

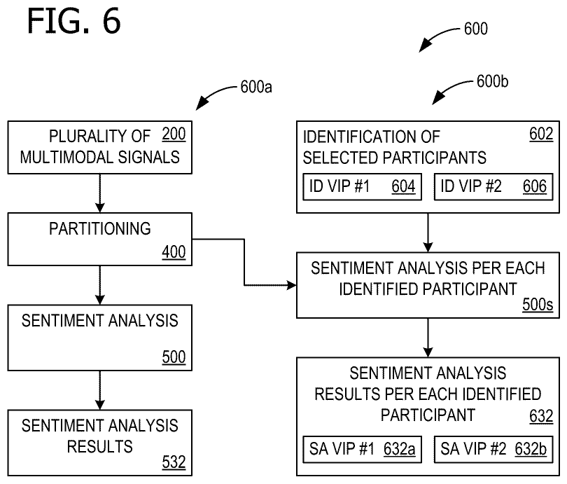

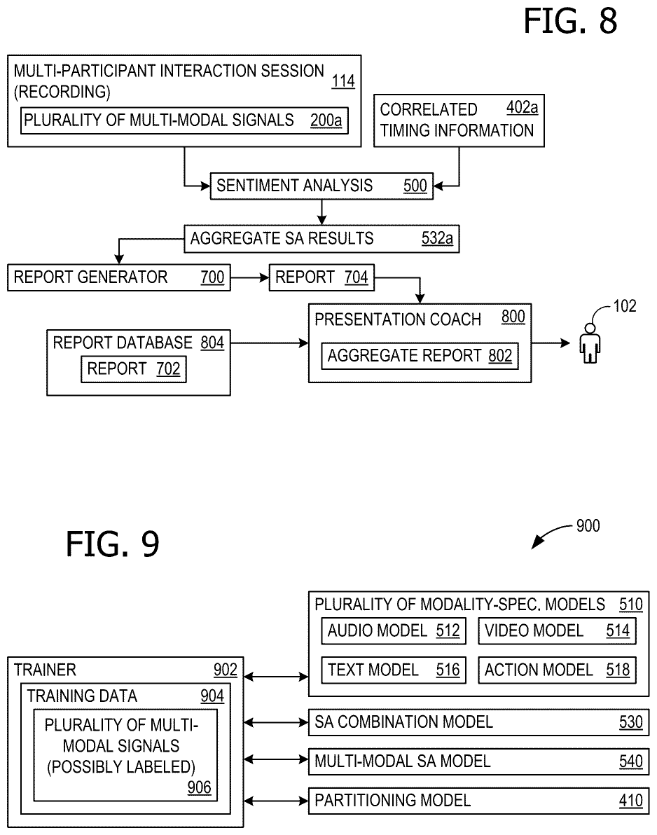

A multi-modal audience response analyzer 120 performs time alignment 122 and partitioning 400 of plurality of multi-modal signals 200, which are shown and described in further detail in relation to FIG. 4. After time alignment 122 and partitioning 400, plurality of multi-modal signals 200 is provided to a sentiment analysis 500, which is shown and described in further detail in relation to FIG. 5. The ability to perform sentiment analysis on the entirety of participants 104 (i.e., the audience as a whole), as well as the particular selected participants 104a and 104b is shown and described in relation to FIG. 7.

Sentiment analysis results are provided to a report generator 700, which generates a report 702, as shown and described in relation to FIG. 7. A presentation coach 800, which, is shown and described in relation to FIG. 8, generates an aggregate report 802 from audience (and selected participant) reactions to multi-participant interaction sessions 112 and 114. Presentation coach 800 uses aggregate report 802 to instruct presenter 102, and others, what to avoid during presentations and what to continue doing, based on the reactions, which can help improve presentation skills, teaching ability, and persuasiveness.

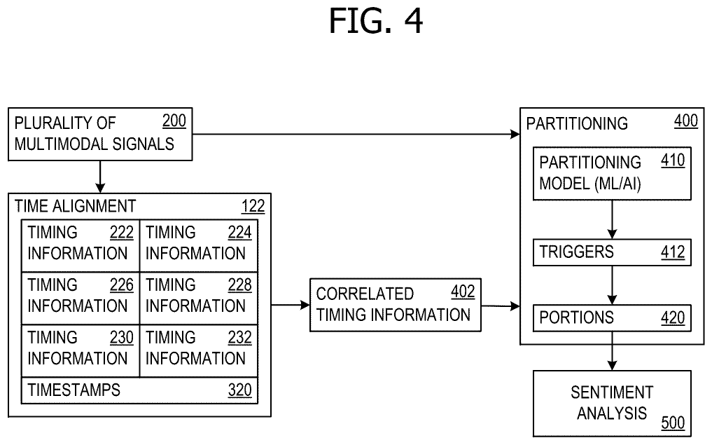

FIG. 2 illustrates further detail for plurality of multi-modal signals 200. As illustrated, plurality of multi-modal signals 200 includes: an audio feed 202, a video feed 204, a chat 206 (i.e., a chat within multi-participant interaction session 112, hosted by presentation platform 110, or even outside multi-participant interaction session 112), participant actions 208 (i.e., hand raising, applause, contemporaneous communication among participants, and other actions enabled by presentation platform 110 within multi-participant interaction session 112), displayed media 210 (e.g., a PowerPoint or other presentation or media such as video clips and photographs), image stills 212 of participants 104 (entire audience and/or selected participants) extracted from video feed 204 or captured directly, and a timestamped transcript 300, which is shown in further detail in FIG. 3. Some examples may use a different set of multi-modal signals.

For example, an office productivity software suite (e.g., M365) may include a video teleconferencing app (with its own chat functionality), an email app, and another real-time communication app (e.g., text or chat) that are all within the purview of the office productivity software suite. As multi-participant interaction session 112 is ongoing, the office productivity software suite may capture emails and other real-time communication that is outside the video teleconferencing app, but is between participants of multi-participant interaction session 112 and contemporaneous with multi-participant interaction session 112. These communications among participants may be included within the sentiment analysis, for example as part of chat 206 and/or participant actions 208. When sentiment analysis is performed on a recorded multi-participant interaction session, timestamps in external emails and communications among participants may be used to determine whether they occurred contemporaneously with the recorded multi-participant interaction session. For example, side-chatting and reading emails that are unrelated to the subject matter of the multi-participant interaction session may be indications of the participant being bored and disengaged.

Each of the multi-modal signals has associated timing information. For example, audio feed 202 has timing information 222, video feed 204 has timing information 224, chat 206 has timing information 226, participant actions 208 has timing information 228, displayed media 210 has timing information 230, image stills 212 has timing information 232, and timestamped transcript 300 has timestamps 320. In some examples, recorder 116 adds timing information 222-232, such as start and stop time for audio feed 202 and video feed 204, and timestamps for chat 206, participant actions 208, and displayed media 210, as recorder 116 captures plurality of multi-modal signals 200.

FIG. 3 illustrates further detail for timestamped transcript 300, which may be added to plurality of multi-modal signals 200, either in near-real time (as timestamped transcript 300 is being generated), or after completion of the recording of multi-participant interaction session 112. Audio feed 202 is provides to a transcription service 302, which may include an automatic speech recognition (ASR) component 304, a speaker identification service 306 that is able to identify when either of selected participants 104a and 104b is speaking, and other vocal detection 308 that identifies laughter, tone of voice, and other sounds that are not recognizable as specific words. Some examples may not use speaker identification service 306 and/or other vocal detection 308.

This generates timestamped transcript 300, which is shown as including text 310 of the spoken words (in some cases) attributed to particular persons (e.g., selected participants 104a and 104b) by speaker identification 312, and indications 314 of laughter, voice tone, and/or other vocal expressions other than words. These are timestamped with timestamps 320, such as periodic timestamps on a schedule or a timestamp specific to an event.

FIG. 4 illustrates further detail for partitioning plurality of multi-modal signals 200 into separately-analyzed portions 420 for performing sentiment analysis. Plurality of multi-modal signals 200 is time aligned by time alignment 122 that uses timing information 222-232 and timestamps 320 to generate correlated timing information 402. Correlated timing information 402 enables other portions of architecture 100 to identify whether certain expressions, such as laughter or applause, captured in audio feed 202 and participant actions 208 follows or precedes certain activities or statements by presenter 102 (e.g., speaking certain words or showing certain elements in displayed media 210).

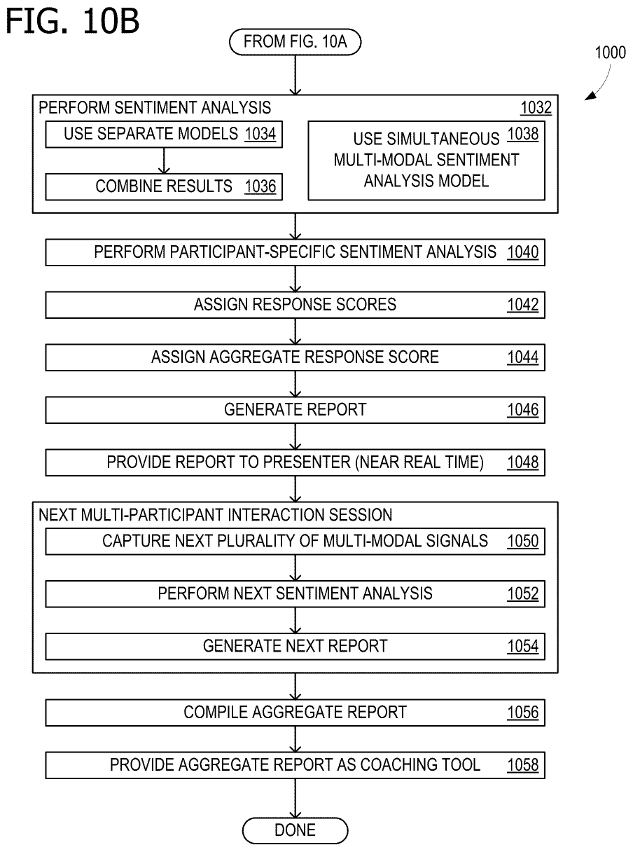

For example, partitioning 400 uses a partitioning model 410 to detect triggers 412 for partitioning plurality of multi-modal signals 200 into separately-analyzed portions 420, which are sent to sentiment analysis 500. Partitioning model 410 may include an ML (or AI) model, and may be trained using the arrangement shown in FIG. 9. A trigger (of triggers 412) is some event that occurs during multi-participant interaction session 112, such as presenter 102 speaking a certain sentence or word(s), or showing some media clip or image, that is likely to trigger an audience reaction different than what had been previously occurring in multi-participant interaction session 112. Such triggers 412 are natural places for partitioning plurality of multi-modal signals 200, including capturing image stills 212 from video feed 204, because the following audience reaction may be correlated with the trigger that leads off the particular partition.

FIG. 5 illustrates exemplary sentiment analyses workflows 500a and 500b. Plurality of multi-modal signals 200, correlated timing information 402, triggers 412, and separately-analyzed portions 420 are provided to a prompt generator 504 that includes them in a prompt 502. Prompt 502 is provided to either workflow 500a or workflow 500b. Workflow 500a uses a plurality of modality-specific ML models 510 that produces separate sentiment analyses 520 (modality-specific sentiment analyses), which are then combined by an ML model 530 into an aggregate sentiment analysis 532 (aggregated over all of the multi-modal signals). Plurality of modality-specific ML models 510 is shown as including an audio model 512 that operates on audio feed 202, a video model 514 that operates on video feed 204, a text model 516 that operates on chat 206 and timestamped transcript 300, and an action model 518 that operates on participant actions 208 and perhaps displayed media 210.

Separate sentiment analyses 520 includes audio sentiment analysis results 522, video sentiment analysis results 524, text sentiment analysis results 526, and action sentiment analysis results 528, that each correspond to the similarly named modality-specific ML model of modality-specific ML models 510. ML model 530 is illustrated as being a sentiment analysis combination model because it combines the separate results of separate sentiment analyses 520 into a coherent, single sentiment analysis result that indicates a positive and/or negative sentiment for each of separately-analyzed portions 420 of multi-participant interaction session 112.

Workflow 500b uses an ML model 540 that is capable of performing multi-modal sentiment analysis across two or more multi-modal signals simultaneously. For example, ML model 540 is capable of performing multi-modal sentiment analysis across all signals of plurality of multi-modal signals 200, simultaneously, and outputs aggregate sentiment analysis 532 as a single stage. There is no need of a version of ML model 530 in workflow 500b. Some examples may use a hybrid, however, in which a version of ML model 540 is capable of performing multi-modal sentiment analysis across more than one, but fewer than all signals of plurality of multi-modal signals 200. In such an example, one or more ML models may be multi-modal, supplemented by modality-specific ML models to address all signals of plurality of multi-modal signals 200, with the separate results combined by a version of ML model 530.

Plurality of modality-specific ML models 510 and ML model 540 each comprises a language model, such as an LLM. Any of modality-specific ML models 510 and ML model 540 may comprise a supervised ML model that maps behavior of presenter 102 and/or messaging content to positive and negative responses. Plurality of modality-specific ML models 510, ML model 540, and ML model 530, may each be trained using the arrangement shown in FIG. 9.

Aggregate sentiment analysis 532 includes separate sentiment analysis results 534 for each portion of separately-analyzed portions 420, allowing for multi-participant interaction session 112 to have portions that go well for presenter 102 (positive sentiment), and poorly for presenter 102 (negative sentiment). Results 534 may be expressed as a numerical response score 536 for each of the separately-analyzed portions 420. In some examples, aggregate sentiment analysis 532 also includes response score 538 for the entirety of multi-participant interaction session 112 (i.e., a sentiment for the event as a whole). Aggregate sentiment analysis 532 is provided to report generator 700, which provides suggestion to presenter 102 (and other readers of report 702) based on positive and negative audience responses.

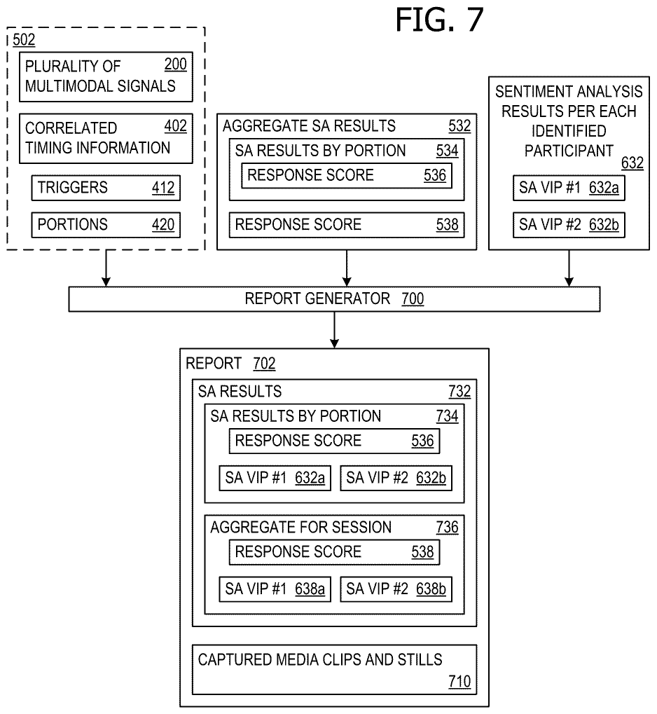

FIG. 6 illustrates performing sentiment analyses both for the entirety of participants 104 (the whole audience) and also for a specific selected participant, such as selected participant 104a and/or selected participant 104b. A generic workflow 600 is separated into a whole audience workflow 600a and a selected participant workflow 600b.

Whole audience workflow 600a is as described previously. Plurality of multi-modal signals 200 is provided to partitioning 400, and then sentiment analysis 500, to produce aggregate sentiment analysis 532. Selected participant workflow 600b starts with identification 602 of selected participants, such as identification 604 of selected participant 104a and/or identification 606 of selected participant 104b. Sentiment analysis 500s is performed on each identified selected participant, such as sentiment analysis 500 as shown in FIG. 5, but with the addition of extracting out specifically-identifiable statements from timestamped transcript 300 using speaker identification 312, and extracting participant-specific facial expressions and body language from video feed 204. Identifying selected participants in video feed 204 may use facial recognition and/or seating chart information.

Performing sentiment analysis 500s on each selected participant generates results such as participant-specific sentiment analyses 632, which includes participant-specific sentiment analysis 602a for selected participant 104a and participant-specific sentiment analysis 602b for selected participant 104b. For example, whole audience workflow 600a may produce a result such as “Slide 5 and your voice-over to this was generally well-received”, which is a general result, whereas selected participant workflow 600b may produce a result such as “Slide 5 and your voice-over to this was well-received by <name of selected participant 104a>”, which is an individual-specific result. In some examples, results from multiple selected participants may be combined, where they all belong to some sub-group of the audience, such as “Slide 5 and your voice-over to this was well-received by the C-suite section of the audience”, which is a grouped result.

FIG. 7 illustrates generation of report 702, which provides suggestion to presenter 102 (and other readers of report 702) based on positive and negative audience responses. Plurality of multi-modal signals 200, correlated timing information 402, triggers 412, separately-analyzed portions 420 (possibly together as prompt 502), aggregate sentiment analysis 532, and participant-specific sentiment analyses 632 are provided to report generator 700. Report generator 700 generates report 702, which is illustrated as containing results 732 of performing the sentiment analysis including results by portion 734 and aggregate results 736 for the entirety of multi-participant interaction session 112 (i.e., a sentiment for the event as a whole).

Results by portion 734 includes, for each of the separately-analyzed portions 420, response score 536 as well as (if available) a portion-specific participant-specific sentiment analysis 632a for selected participant 104a and a portion-specific participant-specific sentiment analysis 632b for selected participant 104b. Aggregate results 736 includes response score 538 (for the whole audience, for the entirety of multi-participant interaction session 112) and participant-specific versions of response score 538, for the entirety of multi-participant interaction session 112, but for the individual selected participants. Results 638a for selected participant 104a and results 638b for selected participant 104b are shown.

Report 702 is also shown as having captured media clips and stills 710, which may include captured images, audio clips and/or video clips. In some scenarios, captured media clips and stills 710 correspond to triggers 412, to enable report 702 to explain which aspects of multi-participant interaction session 112 are responsible for which sentiment analysis results.

In some examples, report 702 is distributed as an electronic multi-media file. In some examples, report 702 is provided to presenter 102 during to multi-participant interaction session 112, as it is generated in near real time (i.e., with minimal delays that are necessarily due to computational delays in ASR and sentiment analysis). For example, presenter 102 may have a small window open in the video teleconference feed that shows sentiment analysis as a graphed score that progresses with time. This feedback gives presenter an opportunity to adjust presentation style while multi-participant interaction session 112 is still ongoing.

FIG. 8 illustrates further detail for presentation coach 800. Presentation coach 800 uses multiple reports similar to report 702 (and which may include report 702), pulled from a report database 804, to generate aggregate report 802. In some examples, presentation coach 800 may be a custom AI assistant build, such as a Copilot or Gemini customization.

An example of generating a second report 704 from multi-participant interaction session 114, to use in generating aggregate report 802, is shown. A second plurality of multi-modal signals 200a is captured from multi-participant interaction session 114, and which has its own audio feed 202 and video feed 204. Timing information 402a across plurality of multi-modal signals 200a is correlated, enabling further sentiment analysis 532a and then generation of report 704 in the manner described for report 702. Presentation coach 800 then combines what is learned from reports 702 and 704, along with other reports, into aggregate report 802. Aggregate report 802 is provided to presenter 102, or another potential presenter, to help improve presentation skills.

FIG. 9 illustrates a training arrangement 900 for training the various ML (or AI) models that may be used by examples of architecture 100. A trainer 902 has training data 904 comprising a plurality of multi-modal signals for training 906. In some scenarios some or all of a plurality of multi-modal signals for training 906 is labeled for training. Trainer 902 uses training data 904 to train each model of plurality of modality-specific ML models 510 for modality-specific sentiment analysis (i.e., to produce separate sentiment analyses 520); to train ML model 530 to combine separate sentiment analyses (i.e., to produce aggregate sentiment analysis 532), to train ML model 540 for multi-modal sentiment analysis (i.e., using two or more multi-modal signals simultaneously), and/or to train ML model 410 to identify triggers for partitioning of a plurality of multi-modal signals into separately analyzable portions.

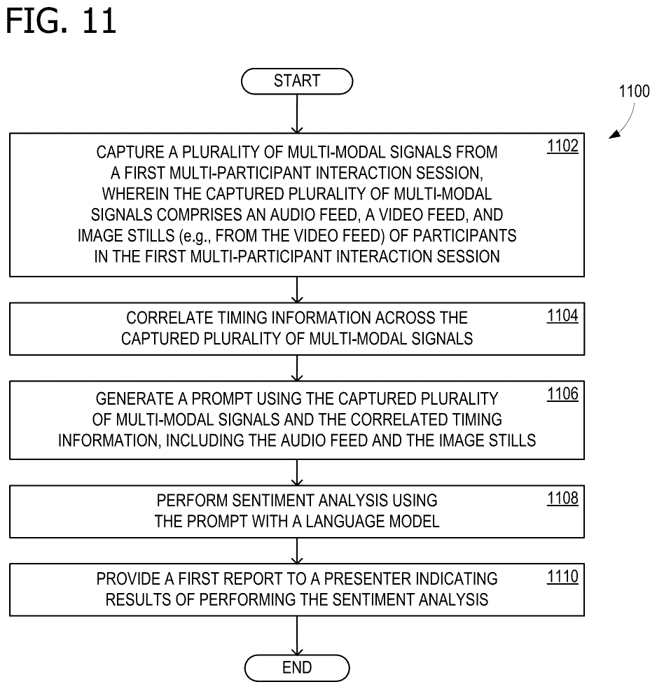

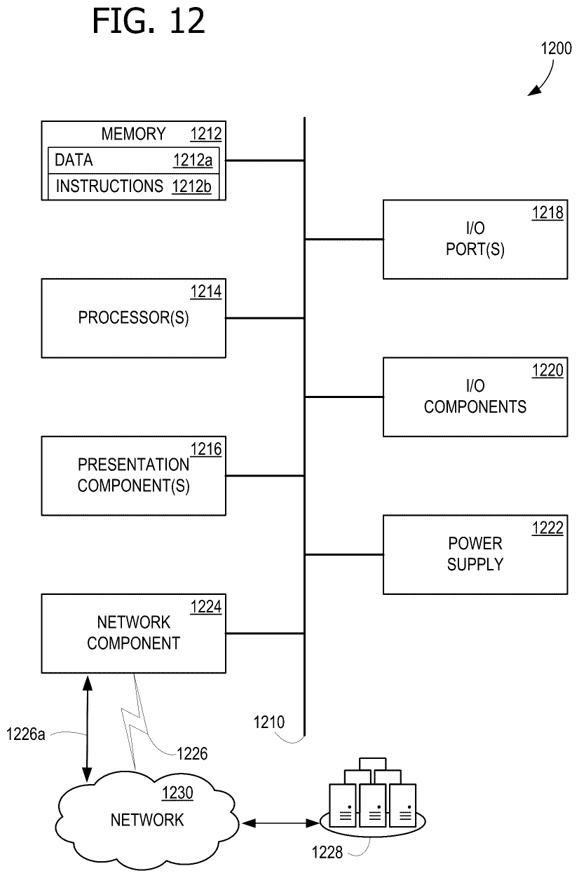

FIGS. 10A and 10B together show a flowchart 1000 illustrating exemplary operations that may be performed by architecture 100. In some examples, operations described for flowchart 1000 are performed by computing device 1200 of FIG. 12. Flowchart 1000 spans FIGS. 10A and 10B and commences with training each of plurality of modality-specific ML models 510 for sentiment analysis in operation 1002, as shown in FIG. 10A. Operation 1004 trains ML model 530 to combine separate sentiment analyses 520 into aggregate sentiment analysis 532, and operation 1006 trains training ML model 540 to perform multi-modal sentiment analysis using two or more multi-modal signals simultaneously. Operation 1008 trains ML model 410 to detect triggers, within a plurality of multi-modal signals, to use for partitioning a multi-participant interaction session into separate portions that are likely to have separate sentiment analysis results.

Presenter 102 starts multi-participant interaction session 112 in operation 1010, in order to give a presentation. Recording of multi-participant interaction session 112 begins in operation 1012. The remainder of flowchart 1000 maybe performed on a live session, such as a live video teleconference, or on a previously recorded session. In operation 1014, participants are selected for participant-specific sentiment analysis, such as selected participant 104a and selected participant 104b, which may be identified in video feed 204 using facial recognition and/or a seating chart.

Operation 1016 captures plurality of multi-modal signals 200 from multi-participant interaction session 112, including audio feed 202 and video feed 204. Some examples also include chat 206, participant actions 208, and displayed media 210. Participant actions 208 may include hand raising and/or applause, and displayed media 210 may comprise a presentation slide deck or a photographic image. Operation 1018 generates timestamped transcript 300 using audio feed 202, and captured plurality of multi-modal signals 200 then further comprises timestamped transcript 300.

Operation 1020 correlates timing information 222-232 and timestamps 320 across captured plurality of multi-modal signals 200, and operation 1022 annotates timestamped transcript 300 with indications 314 of laughter, voice tone, and/or other vocal expressions other than words. Speaker detection is performed on audio feed 202 in operation 1024, and timestamped transcript 300 is annotated with speaker identification 312 in operation 1026. Selected participants 104a and 104b may be identified in speaker identification 312.

Triggers 412 are detected within plurality of multi-modal signals 200 in operation 1028 using ML model 410, and triggers 412 are used to partition multi-participant interaction session 112 into separately-analyzed portions 420 in operation 1030. Illustration of flowchart 1000 continues in FIG. 10B.

Operation 1032 performs sentiment analysis for the entire audience (the aggregation of participants 104) using captured plurality of multi-modal signals 200 (including timestamped transcript 300) and correlated timing information 402. Performing sentiment analysis using audio feed 202 may include detecting laughter, voice tone, and/or vocal expressions other than words, and performing sentiment analysis using video feed 204 may include detecting facial expressions (smiling, frowning, eye rolling), head motions (nodding, shaking side to side, tilting), and/or body language (sitting up, crossing arms). Operation 1032 may be performed using both operations 1034 and 1036 or using operation 1038.

Operation 1034 performs separate sentiment analyses using plurality of modality-specific ML models 510, that had been trained in operation 1002, and operation 1036 uses ML model 530 (trained in operation 1004) to combine separate sentiment analyses 520 into aggregate sentiment analysis 532 (aggregated results) of performing the sentiment analysis. Operation 1036 performs sentiment analysis using ML model 540, which was trained in operation 1006 for multi-modal sentiment analysis across two or more multi-modal signals simultaneously.

Operation 1040 performs participant-specific sentiment analysis for selected participants, such as selected participant 104a and selected participant 104b, similarly to similar to operation 1032 (but as modified slightly, as described in relation to FIG. 6). A response score 536 is assigned for each of separately-analyzed portions 420 of multi-participant interaction session 112 in operation 1042, for both the entire audience, and also an equivalent score (i.e., portion-specific participant-specific sentiment analyses 632a and 632b) for each selected participant. Operation 1044 assigns aggregate response score 538 for (the entirety of) multi-participant interaction session 112, and also an equivalent score (i.e., results 638a and 638b) for each selected participant.

Report 702 is generated in operation 1046. Report 702 correlates triggers 412 with results 534 of performing the sentiment analysis for each of separately-analyzed portions 420 of multi-participant interaction session 112. Results indicate positive and/or negative sentiment (e.g., using response score 536) for each of separately-analyzed portions of multi-participant interaction session 112, and so alert presenter 102 to which of triggers 412 should be avoided in future presentations. Results 534 are aggregated to form aggregate response score 538. In some examples, report 702 also has results of performing participant-specific sentiment analysis attributed to each of selected participant 104a and/or selected participant 104b. In some examples, report 702 additionally has captured images, audio clips and/or video clips from multi-participant interaction session 112, which may be annotated with results of performing the sentiment analyses.

Report 702 is provided to presenter 102 in operation 1048, in near real time during multi-participant interaction session 112 in some examples, although after conclusion of multi-participant interaction session 112 in some examples. For the next multi-participant interaction session 114, plurality of multi-modal signals 200a are captured in operation 1050, and timing information is correlated across captured plurality of multi-modal signals 200a. Operation 1052 performs sentiment analysis using captured plurality of multi-modal signals 200a and correlated timing information 402a, and operation 1054 generates report 704.

Operation 1056 compiles report 702 and report 704 into aggregate report 802, which may include feedback regarding sentiment of selected participant 104a who participated in both multi-participant interaction session 112 and multi-participant interaction session 114. This permits forming a profile of the responses of selected participant 104a across multiple sessions. In operation 1058, aggregate report 802 is provided to presenter 102 as a coaching aid to assist in preparation for another multi-participant interaction session.

FIG. 11 shows a flowchart 1100 illustrating exemplary operations that may be performed by architecture 100. In some examples, operations described for flowchart 1100 are performed by computing device 1200 of FIG. 12. Flowchart 1100 commences with operation 1102, which includes capturing a plurality of multi-modal signals from a first multi-participant interaction session, wherein the captured plurality of multi-modal signals comprises an audio feed, a video feed, and image stills of participants in the first multi-participant interaction session.

Operation 1104 includes correlating timing information across the captured plurality of multi-modal signals. Operation 1106 includes generating a prompt using the captured plurality of multi-modal signals and the correlated timing information, including the audio feed and the image stills. Operation 1108 includes performing sentiment analysis using the prompt with a language model. Operation 1110 includes providing a first report to a presenter indicating results of performing the sentiment analysis.

### Additional Examples

An example system comprises: a processor; and a computer-readable medium storing instructions that are operative upon execution by the processor to: capture a plurality of multi-modal signals from a first multi-participant interaction session, wherein the captured plurality of multi-modal signals comprises an audio feed, a video feed, and image stills of participants in the first multi-participant interaction session; correlate timing information across the captured plurality of multi-modal signals; generate a prompt using the captured plurality of multi-modal signals and the correlated timing information, including the audio feed and the image stills; perform sentiment analysis using the prompt with a language model; and provide a first report to a presenter indicating results of performing the sentiment analysis.

An example computer-implemented method comprises: capturing a plurality of multi-modal signals from a first multi-participant interaction session, wherein the captured plurality of multi-modal signals comprises an audio feed, a video feed, and image stills of participants in the first multi-participant interaction session; correlating timing information across the captured plurality of multi-modal signals; generating a prompt using the captured plurality of multi-modal signals and the correlated timing information, including the audio feed and the image stills; performing sentiment analysis using the prompt with a language model; and providing a first report to a presenter indicating results of performing the sentiment analysis.

One or more example computer storage devices have computer-executable instructions stored thereon, which, on execution by a computer, cause the computer to perform operations comprising: capturing a plurality of multi-modal signals from a first multi-participant interaction session, wherein the captured plurality of multi-modal signals comprises an audio feed, a video feed, and image stills of participants in the first multi-participant interaction session; correlating timing information across the captured plurality of multi-modal signals; generating a prompt using the captured plurality of multi-modal signals and the correlated timing information, including the audio feed and the image stills; performing sentiment analysis using the prompt with a language model; and providing a first report to a presenter indicating results of performing the sentiment analysis.

Alternatively, or in addition to the other examples described herein, examples include any combination of the following:
generating a timestamped transcript using the audio feed;
the captured plurality of multi-modal signals further comprises the timestamped transcript;
performing sentiment analysis comprises performing sentiment analysis using the timestamped transcript;
correlating the timing information across the captured plurality of multi-modal signals includes correlating timestamps of the timestamped transcript with the timing information of another multi-modal signal of the captured plurality of multi-modal signals;
performing participant-specific sentiment analysis for a selected participant;
the first report further comprises results of performing the participant-specific sentiment analysis attributed to the selected participant;
providing the first report to the presenter comprises providing the first report to the presenter in near real time during the first multi-participant interaction session;
providing the first report to the presenter comprises providing the first report to the presenter after conclusion of the first multi-participant interaction session;
the results of performing the sentiment analysis indicate positive and/or negative sentiment for each of separately-analyzed portions of the first multi-participant interaction session;
the first report provides suggestions based on at least the positive and/or negative sentiment;
detecting triggers within the plurality of multi-modal signals for partitioning the first multi-participant interaction session into the separately-analyzed portions;
the first report correlates the triggers with the results of performing the sentiment analysis for each of the separately-analyzed portions of the first multi-participant interaction session;
the first multi-participant interaction session comprises a live video teleconference or a previously recorded video teleconference;
the captured plurality of multi-modal signals further comprises at least one signal selected from the list consisting of: a chat, participant actions, and displayed media;
performing the sentiment analysis comprises performing separate sentiment analyses using a plurality of modality-specific ML models;
performing the sentiment analysis comprises combining the separate sentiment analyses into the results of performing the sentiment analysis using a first ML model;
performing the sentiment analysis comprises performing the sentiment analysis using a second ML model trained for multi-modal sentiment analysis across two or more multi-modal signals simultaneously;
capturing a second plurality of multi-modal signals from a second multi-participant interaction session;
the second captured plurality of multi-modal signals comprises an audio feed, a video feed, and image stills of participants in the second multi-participant interaction session;
correlating timing information across the second captured plurality of multi-modal signals;
performing a further sentiment analysis using the second captured plurality of multi-modal signals and the correlated timing information across the second captured plurality of multi-modal signals;
generating a second report indicating results of performing the further sentiment analysis;
compiling the first report and the second report into an aggregate report;
training each of the plurality of modality-specific ML models for sentiment analysis;
training the first ML model to combine the separate sentiment analyses into an aggregate sentiment analysis;
training the second ML model to perform multi-modal sentiment analysis using two or more multi-modal signals simultaneously;
training a third ML model to detect triggers within a plurality of multi-modal signals to use for partitioning a multi-participant interaction session into separate portions likely to have separate sentiment analysis results;
the displayed media comprises a presentation slide deck or a photographic image;
recording the first multi-participant interaction session;
detecting triggers within the plurality of multi-modal signals using the third ML;
based on at least detecting the triggers, partitioning the first multi-participant interaction session into the separately-analyzed portions;
the participant actions include hand raising and/or applause;
annotating the timestamped transcript with indications of laughter, voice tone, and/or other vocal expressions other than words;
performing speaker detection on the audio feed;
annotating the timestamped transcript with speaker identification;
the selected participant is identified in the speaker identification;
performing sentiment analysis using the audio feed comprises detecting laughter, voice tone, and/or vocal expressions other than words;
performing sentiment analysis using the video feed comprises detecting facial expressions (smiling, frowning, eye rolling), head motions (nodding, shaking side to side, tilting), and/or body language (sitting up, crossing arms);
performing sentiment analysis comprises performing sentiment analysis for an aggregation of participants of the multi-participant interaction session;
performing participant-specific sentiment analysis for a second selected participant;
assigning a response score for each of the separately-analyzed portions of the first multi-participant interaction session;
the results of performing the sentiment analysis comprises the response score for each of the separately-analyzed portions of the first multi-participant interaction session;
assigning an aggregate response score for (the entirety of) the first multi-participant interaction session;
the results of performing the sentiment analysis comprises the aggregate response score;
assigning a response score for each selected participant;
the results of performing the participant-specific sentiment analysis comprises a response score for each selected participant;
generating the first report;
the first report comprises captured images, audio clips and/or video clips from the first multi-participant interaction session;
the captured images, audio clips and/or video clips are annotated with results of performing the sentiment analysis;
the presenter presents during the first multi-participant interaction session;
the presenter is preparing to present during a third multi-participant interaction session; and
the aggregate report comprises feedback regarding sentiment of a selected participant who participated in both the first multi-participant interaction session and the second multi-participant interaction session.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 12 is a block diagram of an example computing device 1200 (e.g., a computer storage device) for implementing aspects disclosed herein, and is designated generally as computing device 1200. In some examples, one or more computing devices 1200 are provided for an on-premises computing solution. In some examples, one or more computing devices 1200 are provided as a cloud computing solution. In some examples, a combination of on-premises and cloud computing solutions are used. Computing device 1200 is but one example of a suitable computing environment and is not intended to suggest any limitation as to the scope of use or functionality of the examples disclosed herein, whether used singly or as part of a larger set.

Neither should computing device 1200 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 1200 includes a bus 1210 that directly or indirectly couples the following devices: computer storage memory 1212, one or more processors 1214, one or more presentation components 1216, input/output (I/O) ports 1218, I/O components 1220, a power supply 1222, and a network component 1224. While computing device 1200 is depicted as a seemingly single device, multiple computing devices 1200 may work together and share the depicted device resources. For example, memory 1212 may be distributed across multiple devices, and processor(s) 1214 may be housed with different devices.

Bus 1210 represents what may be one or more buses (such as an address bus, data bus, or a combination thereof). Although the various blocks of FIG. 12 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 12 and the references herein to a “computing device.” Memory 1212 may take the form of the computer storage media referenced below and operatively provide storage of computer-readable instructions, data structures, program modules and other data for the computing device 1200. In some examples, memory 1212 stores one or more of an operating system, a universal application platform, or other program modules and program data. Memory 1212 is thus able to store and access data 1212a and instructions 1212b that are executable by processor 1214 and configured to carry out the various operations disclosed herein. Thus, computing device 1200 comprises a computer storage device having computer-executable instructions 1212b stored thereon.

In some examples, memory 1212 includes computer storage media. Memory 1212 may include any quantity of memory associated with or accessible by the computing device 1200. Memory 1212 may be internal to the computing device 1200 (as shown in FIG. 12), external to the computing device 1200 (not shown), or both (not shown). Additionally, or alternatively, the memory 1212 may be distributed across multiple computing devices 1200, for example, in a virtualized environment in which instruction processing is carried out on multiple computing devices 1200. For the purposes of this disclosure, “computer storage media,” “computer storage memory,” “memory,” and “memory devices” are synonymous terms for the memory 1212, and none of these terms include carrier waves or propagating signaling.

Processor(s) 1214 may include any quantity of processing units that read data from various entities, such as memory 1212 or I/O components 1220. Specifically, processor(s) 1214 are programmed to execute computer-executable instructions for implementing aspects of the disclosure. The instructions may be performed by the processor, by multiple processors within the computing device 1200, or by a processor external to the client computing device 1200. In some examples, the processor(s) 1214 are programmed to execute instructions such as those illustrated in the flow charts discussed below and depicted in the accompanying drawings. Moreover, in some examples, the processor(s) 1214 represents an implementation of analog techniques to perform the operations described herein. For example, the operations may be performed by an analog client computing device 1200 and/or a digital client computing device 1200. Presentation component(s) 1216 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 1200, across a wired connection, or in other ways. I/O ports 1218 allow computing device 1200 to be logically coupled to other devices including I/O components 1220, some of which may be built in. Example I/O components 1220 include, for example but without limitation, a microphone, joystick, game pad, satellite dish, scanner, printer, wireless device, etc.

Computing device 1200 may operate in a networked environment via the network component 1224 using logical connections to one or more remote computers. In some examples, the network component 1224 includes a network interface card and/or computer-executable instructions (e.g., a driver) for operating the network interface card. Communication between the computing device 1200 and other devices may occur using any protocol or mechanism over any wired or wireless connection. In some examples, network component 1224 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1224 communicates over wireless communication link 1226 and/or a wired communication link 1226a to a remote resource 1228 (e.g., a cloud resource) across a computer network 1230. Various different examples of communication links 1226 and 1226a include a wireless connection, a wired connection, and/or a dedicated link, and in some examples, at least a portion is routed through the internet.

Although described in connection with an example computing device 1200, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
capture a plurality of multi-modal signals from a first multi-participant interaction session, wherein the captured plurality of multi-modal signals comprises an audio feed, a video feed, and image stills of participants in the first multi-participant interaction session;
correlate timing information across the captured plurality of multi-modal signals;
generate a prompt using the captured plurality of multi-modal signals and the correlated timing information, including the audio feed and the image stills;
perform sentiment analysis using the prompt with a language model; and
provide a first report to a presenter indicating results of performing the sentiment analysis.

2. The system of claim 1, wherein the instructions are further operative to:
generate a timestamped transcript using the audio feed, wherein the captured plurality of multi-modal signals further comprises the timestamped transcript, wherein performing sentiment analysis comprises performing sentiment analysis using the timestamped transcript, and wherein correlating the timing information across the captured plurality of multi-modal signals includes correlating timestamps of the timestamped transcript with the timing information of another multi-modal signal of the captured plurality of multi-modal signals.

3. The system of claim 1, wherein providing the first report to the presenter comprises:
providing the first report to the presenter in near real time during the first multi-participant interaction session.

4. The system of claim 1, wherein the results of performing the sentiment analysis indicate positive and/or negative sentiment for each of separately-analyzed portions of the first multi-participant interaction session, and wherein the first report provides suggestions based on at least the positive and/or negative sentiment.

5. The system of claim 1,
wherein the first multi-participant interaction session comprises a live video teleconference or a previously recorded video teleconference; and
wherein the captured plurality of multi-modal signals further comprises at least one signal selected from the list consisting of:
a chat, participant actions, and displayed media.

6. The system of claim 1, wherein the instructions are further operative to:
capture a second plurality of multi-modal signals from a second multi-participant interaction session, wherein the second captured plurality of multi-modal signals comprises an audio feed, a video feed, and image stills of participants in the second multi-participant interaction session;
correlate timing information across the second captured plurality of multi-modal signals;
perform a further sentiment analysis using the second captured plurality of multi-modal signals and the correlated timing information across the second captured plurality of multi-modal signals;
generate a second report indicating results of performing the further sentiment analysis; and
compile the first report and the second report into an aggregate report.

7. A computer-implemented method comprising:
capturing a plurality of multi-modal signals from a first multi-participant interaction session, wherein the captured plurality of multi-modal signals comprises an audio feed, a video feed, and image stills of participants in the first multi-participant interaction session;
correlating timing information across the captured plurality of multi-modal signals;
generating a prompt using the captured plurality of multi-modal signals and the correlated timing information, including the audio feed and the image stills;
performing sentiment analysis using the prompt with a language model; and
providing a first report to a presenter indicating results of performing the sentiment analysis.

8. The method of claim 7, further comprising:
generating a timestamped transcript using the audio feed, wherein the captured plurality of multi-modal signals further comprises the timestamped transcript, wherein performing sentiment analysis comprises performing sentiment analysis using the timestamped transcript, and wherein correlating the timing information across the captured plurality of multi-modal signals includes correlating timestamps of the timestamped transcript with the timing information of another multi-modal signal of the captured plurality of multi-modal signals.

9. The method of claim 8, further comprising:
performing participant-specific sentiment analysis for a selected participant, wherein the first report further comprises results of performing the participant-specific sentiment analysis attributed to the selected participant.

10. The method of claim 7, wherein providing the first report to the presenter comprises:
providing the first report to the presenter in near real time during the first multi-participant interaction session; or
providing the first report to the presenter after conclusion of the first multi-participant interaction session.

11. The method of claim 7, wherein the results of performing the sentiment analysis indicate positive and/or negative sentiment for each of separately-analyzed portions of the first multi-participant interaction session, and wherein the first report provides suggestions based on at least the positive and/or negative sentiment.

12. The method of claim 11, further comprising:
detecting triggers within the plurality of multi-modal signals for partitioning the first multi-participant interaction session into the separately-analyzed portions, wherein the first report correlates the triggers with the results of performing the sentiment analysis for each of the separately-analyzed portions of the first multi-participant interaction session.

13. The method of claim 7,
wherein the first multi-participant interaction session comprises a live video teleconference or a previously recorded video teleconference; and
wherein the captured plurality of multi-modal signals further comprises at least one signal selected from the list consisting of:
a chat, participant actions, and displayed media.

14. The method of claim 7, wherein performing the sentiment analysis comprises:
either:
performing separate sentiment analyses using a plurality of modality-specific machine learning (ML) models; and
combining the separate sentiment analyses into the results of performing the sentiment analysis using a first ML model;
or:
performing the sentiment analysis using a second ML model trained for multi-modal sentiment analysis across two or more multi-modal signals simultaneously.

15. The method of claim 7, further comprising:
capturing a second plurality of multi-modal signals from a second multi-participant interaction session, wherein the second captured plurality of multi-modal signals comprises an audio feed, a video feed, and image stills of participants in the second multi-participant interaction session;
correlating timing information across the second captured plurality of multi-modal signals;
performing a further sentiment analysis using the second captured plurality of multi-modal signals and the correlated timing information across the second captured plurality of multi-modal signals;
generating a second report indicating results of performing the further sentiment analysis; and
compiling the first report and the second report into an aggregate report.

16. A computer storage device having computer-executable instructions stored thereon, which, on execution by a computer, cause the computer to perform operations comprising:
capturing a plurality of multi-modal signals from a first multi-participant interaction session, wherein the captured plurality of multi-modal signals comprises an audio feed, a video feed, and image stills of participants in the first multi-participant interaction session;
correlating timing information across the captured plurality of multi-modal signals;
generating a prompt using the captured plurality of multi-modal signals and the correlated timing information, including the audio feed and the image stills;
performing sentiment analysis using the prompt with a language model; and
providing a first report to a presenter indicating results of performing the sentiment analysis.

17. The computer storage device of claim 16, wherein the operations further comprise:
generating a timestamped transcript using the audio feed, wherein the captured plurality of multi-modal signals further comprises the timestamped transcript, wherein performing sentiment analysis comprises performing sentiment analysis using the timestamped transcript, and wherein correlating the timing information across the captured plurality of multi-modal signals includes correlating timestamps of the timestamped transcript with the timing information of another multi-modal signal of the captured plurality of multi-modal signals.

18. The computer storage device of claim 16, wherein the operations further comprise:
detecting triggers within the plurality of multi-modal signals for partitioning the first multi-participant interaction session into separately-analyzed portions, wherein the first report correlates the triggers with the results of performing the sentiment analysis for each of the separately-analyzed portions of the first multi-participant interaction session, and wherein the results of performing the sentiment analysis indicate positive and/or negative sentiment for each of the separately-analyzed portions of the first multi-participant interaction session.

19. The computer storage device of claim 16, wherein the operations further comprise:
performing the sentiment analysis using a machine learning (ML) model trained for multi-modal sentiment analysis across two or more multi-modal signals simultaneously.

20. The computer storage device of claim 16, wherein the operations further comprise:
capturing a second plurality of multi-modal signals from a second multi-participant interaction session, wherein the second captured plurality of multi-modal signals comprises an audio feed, a video feed, and image stills of participants in the second multi-participant interaction session;
correlating timing information across the second captured plurality of multi-modal signals;
performing a further sentiment analysis using the second captured plurality of multi-modal signals and the correlated timing information across the second captured plurality of multi-modal signals;
generating a second report indicating results of performing the further sentiment analysis; and
compiling the first report and the second report into an aggregate report.
